(19) United States
(12) Patent Application Publication
(10) Pub. No.: US 2005/0057001 A1
(43) Pub. Date: Mar. 17, 2005

(54) Motor drive control device utilizable for gaming machine and gaming machine using the same

(76) Inventor: Takao Nireki, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/936,672

(22) Filed: Sep. 9, 2004

(30) Foreign Application Priority Data
Sep. 11, 2003 (JP) JP2003-319698

(51) Int. Cl. A63F 9/24; G07F 17/34

(52) U.S. Cl. 273/292; 463/20

(57) ABSTRACT

The motor drive control device of the reel-type gaming machine 1 has the stepping motors 49 as the drive source of the reels 3 on which plural symbols are formed, and the stepping motors 49 are driven corresponding to the drive instruction from an external. And the motor drive control device has the motor drive circuit 39 which repeatedly applies the pulse signal with the on-time and the off-time to the stepping motors 49 when the drive instruction of the stepping motors 49 occurs based on the instruction from an external, thereby the stepping motors 49 are driven.

### CROSS-REFERENCE TO THE RELATED APPLICATION (S)

This application is based upon and claims a priority from the prior Japanese Patent Application No. 2003-319698 filed on Sep. 11, 2003, the entire contents are incorporated herein by reference. This application is related to co-pending U.S. applications entitled “MOTOR STOP CONTROL DEVICE UTILIZABLE FOR REEL-TYPE GAMING MACHINE”, filed on Apr. 29, 2004 and entitled “MOTOR STOP CONTROL DEVICE FOR GAMING MACHINE AND GAMING MACHINE PROVIDED WITH THE MOTOR STOP CONTROL DEVICE”, filed on Jul. 30. 2004. The co-pending application is expressly incorporated herein by reference.

### BACKGROUND OF THE INVENTION

1. Field of the Invention

The present invention relates to a motor drive control device utilizable for a reel-type gaming machine and a gaming machine using the motor drive control device, such gaming machine having motors as drive sources of reels on each of which a plurality of symbols are formed and the motors being driven corresponding to an instruction command transmitted from an external.

2. Description of Related Art

Conventionally, in a symbol display device, which variably displays symbols, utilized in a reel-type gaming machine (for example, a Japanese Pachi-slot machine), as shown in Unexamined Japanese Patent Publication No. 10-71240, it is utilized a circuitry construction through which the reel on which a plurality of symbols are formed is rotated by applying a predetermined voltage value (for example, 24V) to the motor which is driven by such predetermined voltage value.

However, since the above predetermined voltage value (24V) is higher than the other voltage value (for example, 12V) which is utilized in the reel-type gaming machine to drive the other members, a power source cannot be commonly used in the reel-type gaming machine. Therefore, there is a problem that manufacturing cost of the reel-type gaming machine cannot be reduced.

On the other hand, if the motor driven by the other lower voltage value (for example, 12V) is used in the reel-type gaming machine, instead of the motor which is driven by the above predetermined voltage value (for example, 24V), the power source is commonly used in the reel-type gaming machine and manufacturing cost thereof can be reduced.

However, in a case that the lower voltage value is merely used, a rise time of the current flowing in the motor is delayed, thereby the motor cannot be efficiently driven.

Taking the above situation into consideration, it is desired a device through which manufacturing cost of the reel-type gaming machine can be reduced and the motor can be efficiently driven, thereby interest for games can be raised.

### SUMMARY OF THE INVENTION

The present invention has been done to accomplish the above problems and has an object to provide a motor drive control device through which manufacturing cost of the reel-type gaming machine can be reduced and the motor can be efficiently driven, thereby interest for games can be raised.

According to one aspect of the present invention, it is provided a motor drive control device utilizable for a gaming machine comprising:
a motor for rotating a reel on which a plurality of symbols are formed; and
a motor drive controller for driving and controlling the motor;
wherein the motor drive controller repeatedly applies a pulse signal with an on-time and an off-time to the motor based on a motor drive instruction.

According to the motor drive control device, when the drive instruction occurs, the motor drive controller repeatedly applies the pulse signal with an on-time and an off-time to the motor, thereby the motor drive control device can efficiently drive the motor with a low voltage value. Accordingly, power source of the gaming machine can be commonly utilized and manufacturing cost of the gaming machine can be reduced.

According to another aspect of the present invention, it is provided a gaming machine comprising:
a motor drive control device;
wherein the motor control device comprises:
a motor for rotating a reel on which a plurality of symbols are formed; and
a motor drive controller for driving and controlling the motor;
wherein the motor drive controller repeatedly applies a pulse signal with an on-time and an off-time to the motor based on a motor drive instruction.

According to the above gaming machine, when the drive instruction occurs, the motor drive controller in the gaming machine repeatedly applies the pulse signal with an on-time and an off-time to the motor, thereby the motor drive control device can efficiently drive the motor with a low voltage value. Thus, power source of the gaming machine can be commonly utilized and manufacturing cost of the gaming machine can be reduced.

As mentioned, according to the present invention, manufacturing cost of the gaming machine can be reduced, therefore not only the motor can be efficiently driven but also interest for games can be raised.

The above and further objects and novel features of the invention will more fully appear from the following detailed description when the same is read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is a perspective view of a gaming machine according to the embodiment,

FIG. 2 is a perspective view showing a construction of reels when obliquely seeing the reels in the embodiment,

FIG. 3 is a side view of the reel in the embodiment,

FIG. 4 is an explanatory view showing a shaft support portion of the reel in the embodiment,

FIG. 5 is a sectional view showing a construction in which the shaft support portion is arranged on a support plate, in the embodiment,

FIG. 6 is a block diagram of the reel-type gaming machine according to the embodiment,

FIG. 7 is a flowchart showing procedures of the reel-type gaming machine according to the embodiment,

FIG. 8 is an explanatory view showing a selection lottery table in which each winning combination and each on-time of a pulse signal are corresponded,

FIG. 9 is an explanatory view showing a voltage wave and a current wave when on-state and off-state of the pulse signal are repeatedly switched, FIG. 9A shows the voltage wave against the time and FIG. 9B shows the current wave against the time,

FIG. 10 an explanatory view showing a voltage wave and a current wave when an on-state and an off-state of the pulse signal are repeatedly switched, FIG. 10A shows the voltage wave against the time and FIG. 10B shows the current wave against the time,

FIG. 11 an explanatory view showing a voltage wave and a current wave when the on-state and the off-state of the pulse signal are repeatedly switched, FIG. 11A shows the voltage wave against the time and FIG. 11B shows the current wave against the time,

FIG. 12 a flowchart showing procedures of the reel-type gaming machine according to the embodiment, the procedures being executed continuously to the procedures shown in FIG. 7, and

FIG. 13 is a flowchart showing procedures of the reel-type gaming machine according to the embodiment, the procedures being executed continuously to the procedures shown in FIG. 12.

### DETAILED DESCRIPTION OF THE PREFERRED EMBODIMENTS

(Basic Construction of Motor Drive Control Device)

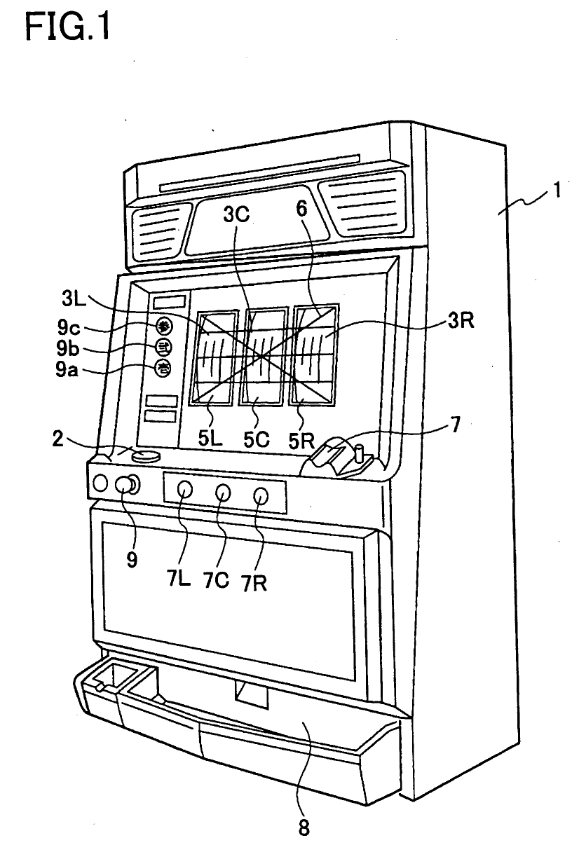

The motor drive control device of the embodiment will be described with reference to the drawings. FIG. 1 is a perspective view of a reel-type gaming machine according to the embodiment.

As shown in FIG. 1, in front of a cabinet forming a whole construction of the reel-type gaming machine 1, three panel display windows 5L, 5C, 5R are formed. Reels 3L, 3C, 3R constructing a reel unit are seen and recognized through the panel display windows 5L, 5C, 5R, respectively. And on the panel display windows 5L, 5C, 5R, three pay lines 6 are described along three horizontal directions and two pay lines 6 are described along two oblique directions. These pay lines 6 are made effective according to the number of coins inserted through an insertion slot 7 and the number of pay lines 6 are determined.

Each of the reels 3L, 3C, 3R starts to rotate when a player inserts coins in the insertion slot 7 and operates a start lever 9. And when the player presses stop buttons 7L, 7C, 7R arranged corresponding to the reels 3L, 3C, 3R respectively, rotation of the reels 3L, 3C, 3R is stopped. Further, based on symbol combination of each of reels 3L, 3C, 3R which are seen and recognized through each of the panel display windows 5L, 5C, 5R when rotation of the reels 3L, 3C, 3R is stopped, winning mode is determined. And when winning is obtained, coins the number of which corresponds to the winning mode are paid out to a coin tray 8.

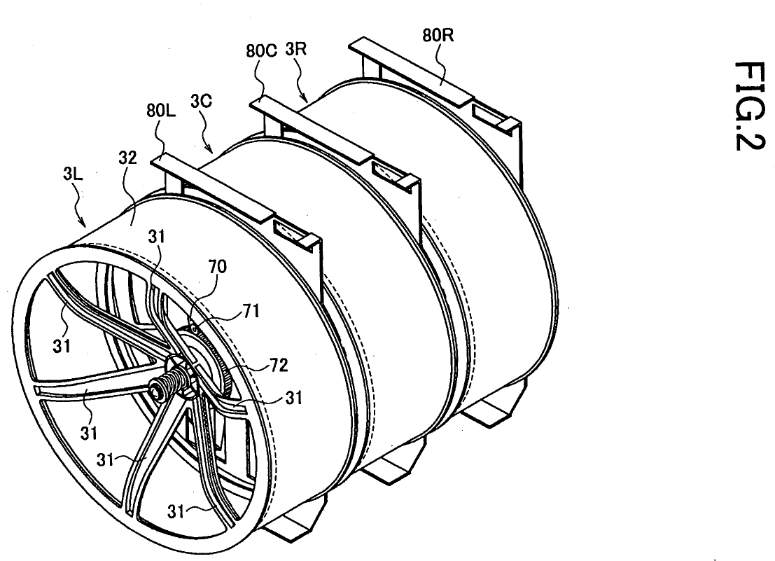

FIG. 2 is a perspective view showing the construction of the reel unit arranged within the panel display windows 5L, 5C, 5R. As shown in FIG. 2, the reel unit has three support plates 80L, 80C, 80R, three reels 3L, 3C, 3R arranged inside of each support plate 80L, 80C, 80R, respectively, and three stepping motors 49L, 49C, 49R of PM type rotating the reels 3L, 3C, 3R, respectively.

Hereinafter, for convenience sake of explanation, although description will be done to limit to the left reel 3L (reel 3), the left support plate 80L (support plate 80), the left stepping motor 49L (stepping motor 490), among three reels 3L, 3C, 3R, three support plates 80L, 80C, 80R, three stepping motors 49L, 49C, 49R, the other reels 3C, 3R, the other support plates 80C, 80R, the other stepping motors 49C, 49R have the same construction as those of the reel 3L, the support plate 80L, the stepping motor 49L, so long as explanation is not especially referred.

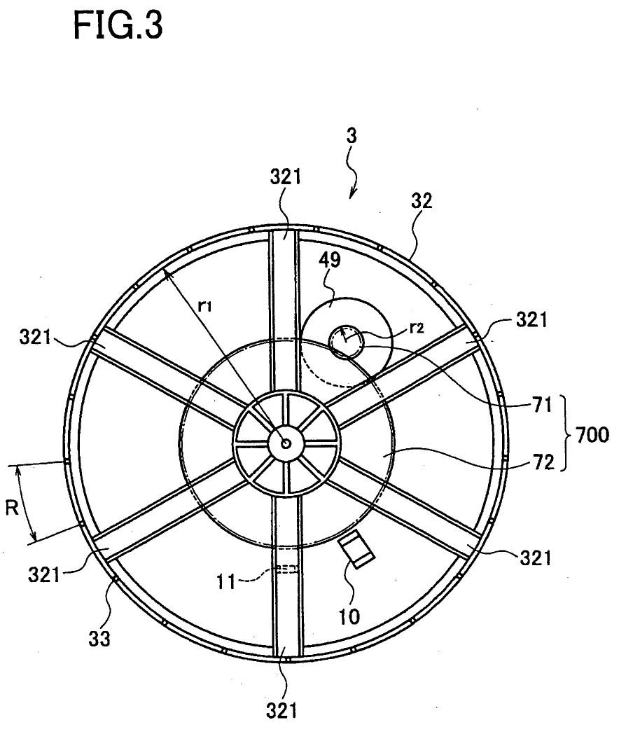

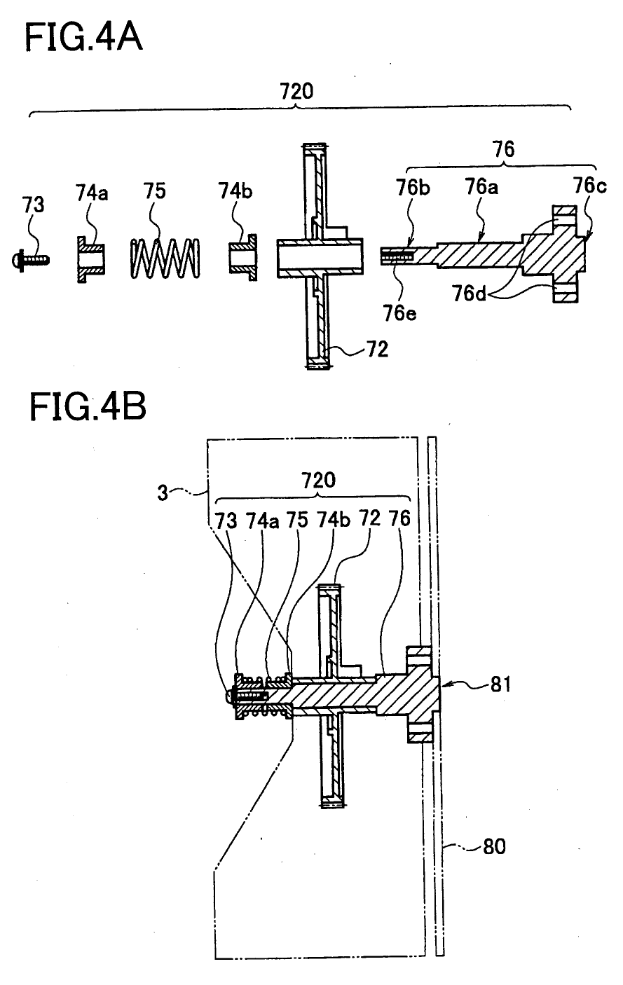

FIG. 3 is the left side view of the reel 3. As shown in FIG. 3, on the support plate 80 (not shown), it is arranged a position detecting sensor 10 for detecting the rotation position of the reel 3 and functioning as the reel position detecting circuit, within the rotation radius r1 of the reel 3. The reel 3 is rotatably supported to a reel post 76 which corresponds to the center of the reel 3 and is extended normally to the plane of the support plate 80 (see FIG. 4).

As shown in FIG. 3, the reel 3 is constructed from six arms 321 extending spokewise from the center of the reel 3 and a cylindrical member 32 integrally formed so that top ends of the arms 321 are connected thereto. To one of the arms 321, it is provided a detection member 11 at a position where the position detecting sensor 10 can detect, the detection member 11 functioning as the standard position. The detection member 11 is positioned so as to pass the position detecting sensor 10 every the reel 3 rotates by one rotation. Further, the position detecting sensor 10 is formed so as to be able to output a detection signal every detection of the detection member 11 when the detection member 11 passes therethrough.

A speed reduction transmission mechanism 700 is arranged between a drive shaft of the stepping motor 49 and a rotation shaft of the reel 3, as shown in FIG. 3. This speed reduction transmission mechanism 700 transmits rotation of the stepping motor 49 to the rotation shaft of the reel 3 with a predetermined reduction ratio.

As shown in FIG. 3, the speed reduction transmission mechanism 700 has two gears, one of which is an output gear 71 put on the drive shaft of the stepping motor 49 and the other is an input gear 72 meshing with the output gear 71 and being arranged in the reel 3 so that the rotation center of the input gear becomes the same shaft center as the rotation shaft of the reel 3.

The reduction ratio of the above output gear 71 and the input gear 72 is obtained based on the ratio of the step number necessary for one rotation of the stepping motor 49 and the least common multiple calculated from the symbol number described on the reel 3 and the step number for one rotation of the stepping motor 49.

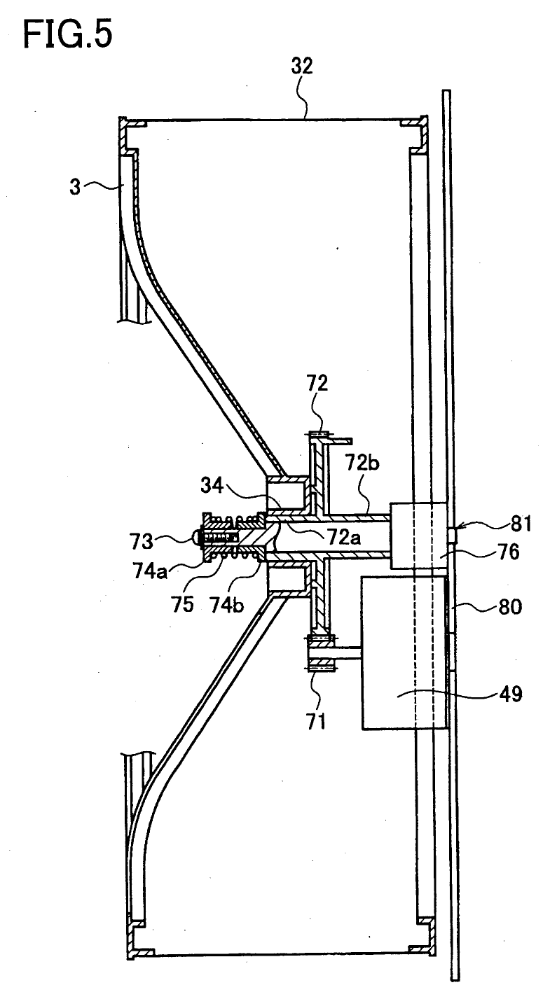

FIG. 4A is an explanatory view indicating a construction of the shaft support part 720 for rotatably supporting the reel 3. FIG. 4B is an explanatory view indicating a construction for supporting the reel 3 by the shaft support part 720 arranged on the support plate 80. And FIG. 5 is a sectional view indicating a whole construction for supporting the reel 3 by the shaft support part 720.

As shown in FIG. 4A, the shaft support part 720 has a stopper screw 73, colors 74a, 74b, a vibration restraining member 75 and a reel post 76. The reel post 76 is provided with a rotation support portion 76a to which the input gear 72 is inserted and rotatably supported, a position fixing portion 76b to which a member for fixing the position of the reel 3 is inserted, a projection portion 76c which projected toward the support plate 80 from the bottom plane of the reel post 76 and is utilized for inserting the reel post 76 in a hole 81 formed in the support plate 80, screw holes 76d for fixing the reel post 76 to the support plate 80 by screws and a screw hole 76e in which the stopper screw 73 is fastened while the input gear 72 is inserted to the rotation support portion 76a and the colors 74a, 74b are inserted to the position fixing portion 76b while existing the vibration restraining member 75 therebetween, thereby the input gear 72 is prevented from coming off from the reel post 76.

The vibration restraining member 75 has function to brake rotation of the reel 3 when the reel 3 is rotating, based on stop control by the main CPU 31, and to decline vibration of the reel 3 occurring when rotation of the reel 3 is stopped. As the vibration restraining member 75, springs can be utilized. In the embodiment, description will be done according that the spring 75 shown in FIG. 4A is used as the vibration restraining member. As shown in FIG. 4B, the input gear 72 is inserted to the rotation support portion 76a, the spring 75 is inserted to the position fixing portion 76b while being sandwiched between the colors 74a and 74b.

The above mentioned stopper screw 73 is, as shown in FIG. 4B, inserted and fastened to the screw hole 76e, thereby the colors 64a, 74b and the spring 75 inserted to the position fixing portion 76b are prevented from coming off therefrom. The spring 75, which is prevented from coming off by the stopper screw 73, presses the input gear 72 toward the support plate 80 through the color 74b by its resilient force. At that time, frictional force occurs between the input gear 72 and the support plate 80, thereby the spring 75 can decline vibration of the reel 3 occurring when the reel 3 is stopped.

As shown in FIG. 5, in the input gear 72, two cylindrical projection portions 72a and 72b are integrally formed from both sides of the plate portion. Both the cylindrical projection portions 72a, 72b are perpendicularly projected from both sides of the plate portion, thereby the rotation support portion 76a can be inserted through the cylindrical projection portions 72a, 72b along an axis passing through the center of the cylindrical projection portions 72a, 72b. The input gear 72 is inserted to the rotation support portion 76a so that one cylindrical projection portion 72b faces to the support plate 80. The other cylindrical projection portion 72a is pressed into the hole 34 formed at the center position of the reel 3. Therefore, when the output gear 71 is rotated, the input gear 72 and the reel 3 are rotated all together around the rotation support portion 76a.

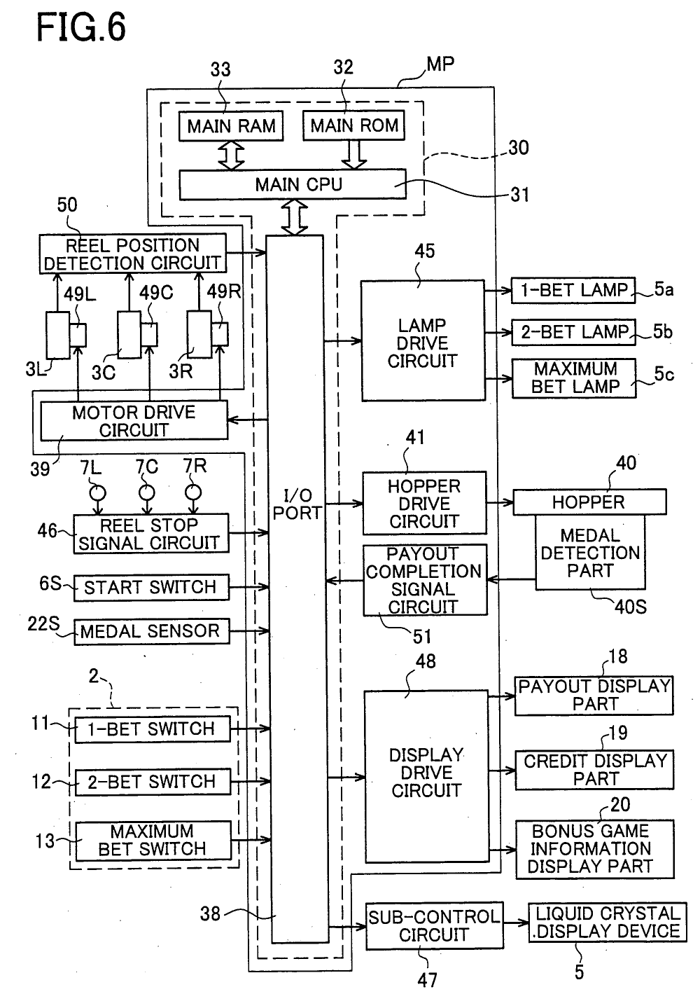

FIG. 6 is a block diagram indicating an electrical construction of the reel-type gaming machine 1, including the motor drive control device. The motor drive control device is provided with the stepping motor 49, as the drive source of the reel 3 having a plurality of symbols, and stops the stepping motor 49 corresponding to an instruction command transmitted from an external.

As shown in FIG. 6, in a microcomputer MP, there are provided a main CPU 31 functioning as a main controller for mainly controlling and calculating, a main ROM 32 for storing programs and various data, a main RAM 33 utilized for data reading and writing, and a random number generator (not shown) for generating predetermined random number values.

Input parts such as a start switch 6S for detecting operation of the start lever 9, a reel stop signal circuit 46 for detecting operation of the stop buttons 7L, 7C, 7R, an input part 2 including BET switches 11˜13 for betting credited coins by pressing thereof and output parts such as a motor drive circuit 39, a lamp drive circuit 45, a hopper drive circuit 41 and a display drive circuit 48 are connected to the main CPU 31.

The main CPU 31 functions as the winning combination determination device for determining (conducting the lottery process) a predetermined symbol combination as the winning combination. Concretely, the main CPU 31 determines the predetermined symbol combination as the winning combination when operation of the start lever 9 is detected by the start switch 6S.

The motor drive circuit 39 drives or stops the stepping motor 49 based on commands from the main CPU 31. Here, the stepping motor 49 is 4-phase motor and has four drive coils through A-phase to D-phase. And in the embodiment, each phase is defined so as to stand in order A-phase, B-phase, C-phase and D-phase in anti-clockwise direction. Further, A-phase and C-phase or B-phase and D-phase forms one pair and current running in one phase in the one pair of two phases has the reverse phase different from current running in the other phase in one pair.

The motor drive circuit 39 serially excites the drive coil in each phase based on commands from the main CPU 31, thereby the rotor in the stepping motor 49 is driven to rotate.

When the drive instruction of the stepping motor 49 occurs based on the instruction from an external, the motor drive circuit 39 in the embodiment repeatedly applies a pulse signal having an on-time and an off-time to the stepping motor 49, thereby the stepping motor 49 is driven. Thus, the motor drive circuit 39 functions as motor drive control device. Concretely, the motor drive circuit 39 executes chopping control method in which the on-state and the off-state of the pulse signal are repeated when operation of the start lever 9 is detected by the start switch 6S through the main CPU 31.

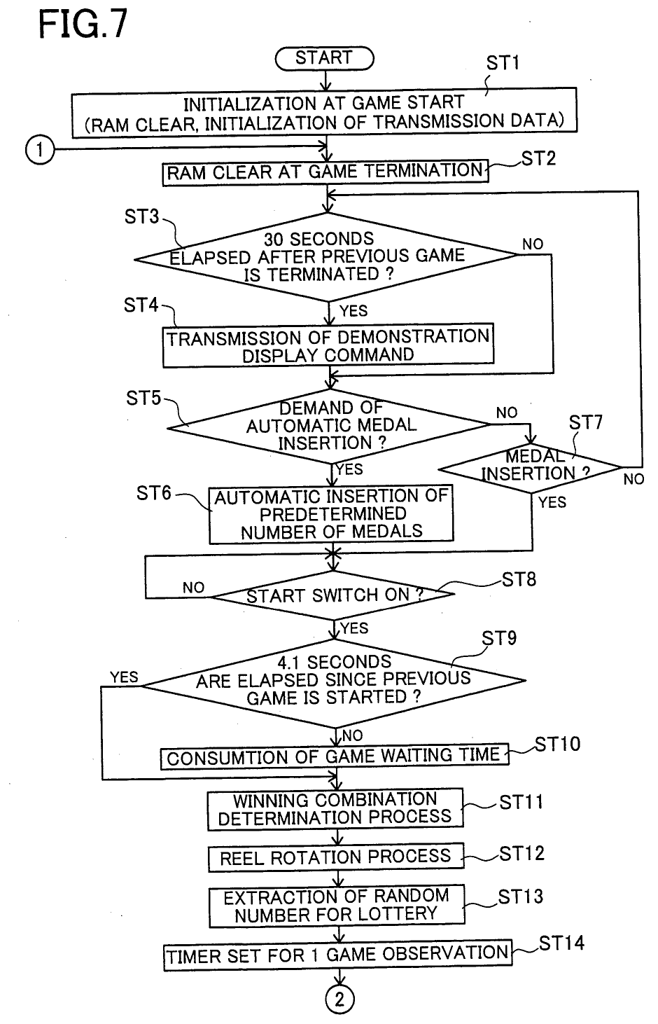

Here, the main CPU 31 may determine the on-time of the pulse signal corresponding to kinds of the determined winning combinations (this determination will be described in detail in step 12 shown in FIG. 7).

And the motor drive circuit 39 may drive the stepping motor 49 (this process will be described in detail in step 12 shown in FIG. 7) by repeatedly applying the pulse signal with the on-time and the off-time each of which is determined by the main CPU 31 and the other of which is preset beforehand, during a time till a predetermined time is elapsed since the drive instruction occurs based on the instruction from an external.

(Reel Stop Control Method by the Motor Drive Control Device)

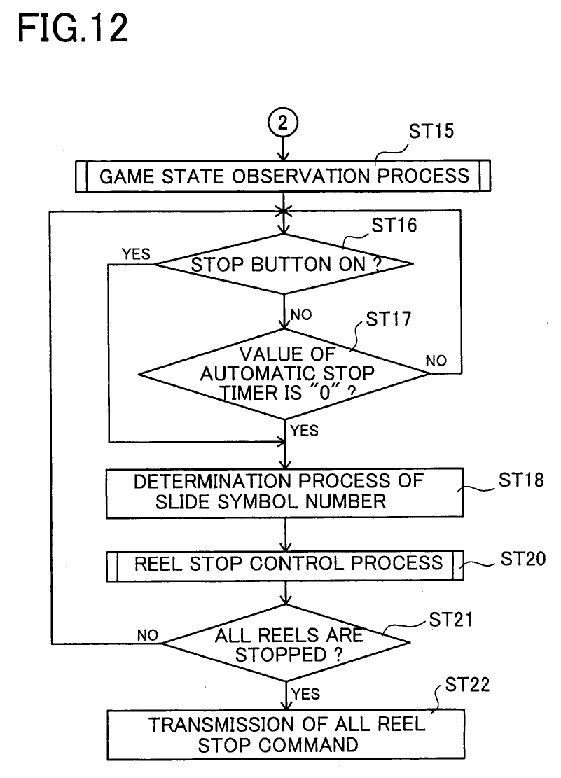

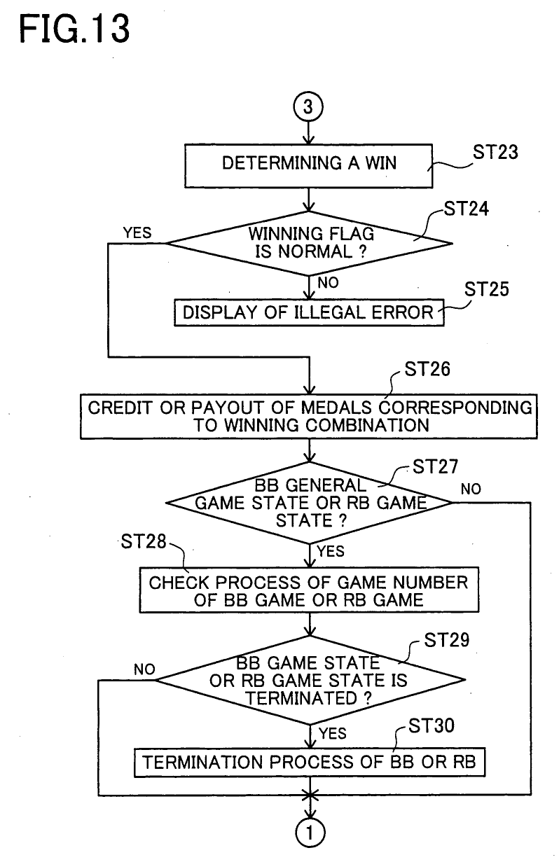

The reel stop control method by the motor drive control device constructed according to the above will be executed by the following procedures. FIGS. 7, 12 and 13 are flowcharts showing operation of the motor drive control device.

As shown in FIG. 7, in step 1 (abbreviated as “ST1” hereinafter), the main CPU 31 initializes predetermined data (data stored in the main RAM 33, transmission data and the like).

In ST2, the main CPU 31 erases the data stored in the main RAM 33 at the time that the previous game is terminated. Concretely, the main CPU 31 erases parameters utilized in the previous game from the main RAM 33 and writes parameters utilized in the next game in the main RAM 33.

In ST3, the main CPU 31 determines whether or not 30 seconds are elapsed since the previous game is terminated (all reels 3L, 3C, 3R are stopped). In a case that 30 seconds are elapsed, the main CPU 31 executes the process in ST4, and on the other hand, if 30 seconds are not elapsed, the main CPU 31 executes the process in ST5.

Here, in ST4, the main CPU 31 transmits “demonstration display command” to display demonstration image to a sub-control circuit 47.

In ST5, the main CPU 31 determines whether or not the “replay”, which is one of the winning combinations, is won in the previous game. In a case that the “replay” is won, the main CPU 31 executes the process in ST6, and if the “replay” is not won, the main CPU 31 executes the process in ST7.

Here, in ST6, the main CPU 31 automatically inserts a predetermined number of medals based on that the “replay” is won.

In ST7, the main CPU 31 determines whether or not medals are inserted by the player. Concretely, the main CPU 31 determines whether or not the switch signal is input from the medal sensor 22S or one of the BET switches 2a-2c. And in a case that such switch signal is input to the main CPU 31, the main CPU 31 executes the process in ST8. On the other hand, in a case that such switch signal is not input to the main CPU 31, the main CPU 31 executes the process in ST3.

In ST8, the main CPU 31 determines whether or not the star lever 9 is operated by the player. Concretely, the main CPU 31 determines whether or not the switch signal is input from the start switch 6S. And in a case that the switch signal is input from the start switch 6S, the main CPU 31 executes the process in ST9.

In ST9, the main CPU 31 determines whether or not 4.1 seconds are elapsed since the previous game is started. And in a case that 4.1 seconds are elapsed, the main CPU 31 executes the process in ST11, and on the other hand, in a case that 4.1 seconds are not elapsed, the main CPU 31 executes the process in ST10.

In ST10, the main CPU 31 invalidates the input from the start switch 6S till 4.1 seconds are elapsed since the previous game is started.

In ST11, the main CPU 31 determines the predetermined symbol combination as the winning combination based on a lottery result.

In ST12, the main CPU 31 transmits the instruction command to the motor drive circuit 39 so that the reels 3 are rotated. Here, the main CPU 31 in the embodiment drives the stepping motor 49 by utilizing the chopping control method in which the on-state and the off-state of the pulse signal are repeated. Conventionally, in order to drive the stepping motor 49, the main CPU 31 drives the stepping motor 49 by utilizing the control method in which a constant voltage is applied to the stepping motor 49. However, in the reel-type gaming machine 1, since a lower voltage than the constant voltage is also utilized, the power source cannot be commonly used in the reel-type gaming machine. Therefore, there exists a problem that manufacturing cost of the reel-type gaming machine cannot be reduced. Contrarily, if the lower voltage is applied to the stepping motor 49, capacity of the power source becomes small. Thus, the power source can be commonly used and manufacturing cost of the reel type gaming machine can be reduced. However, in this case, the voltage value applied to the stepping motor 49 is lower than the standard voltage value and the current rise time flowing in the stepping motor 49 is delayed. Therefore, the stepping motor 49 in the reel-type gaming machine 1 cannot be efficiently driven. Considering this situation, the main CPU 31 in the embodiment according to the present invention drives the stepping motor 49 by the constant current drive method (chopping control method). Thereby, the power source of the reel-type gaming machine 1 can be commonly utilized and manufacturing cost of the reel-type gaming machine 1 can be reduced. Further, in such reel-type gaming machine 1, the current rise time flowing in the stepping motor 49 can be shortened. Accordingly, the stepping motor 49 can be efficiently driven.

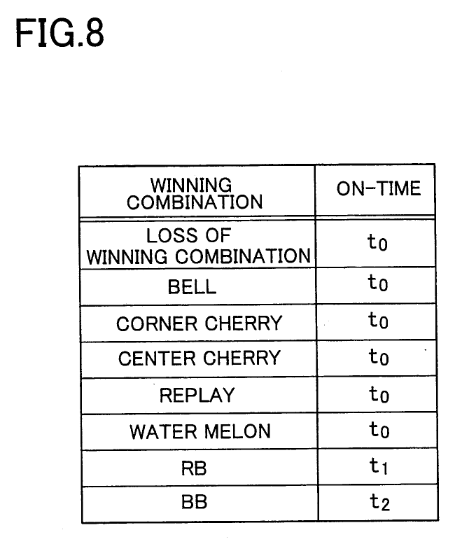

Here, FIG. 8 shows a selection lottery table utilized when the on-time of the pulse signal is determined. In the selection lottery table shown in FIG. 8, the on-times of the pulse signal correspond to kinds of the winning combinations.

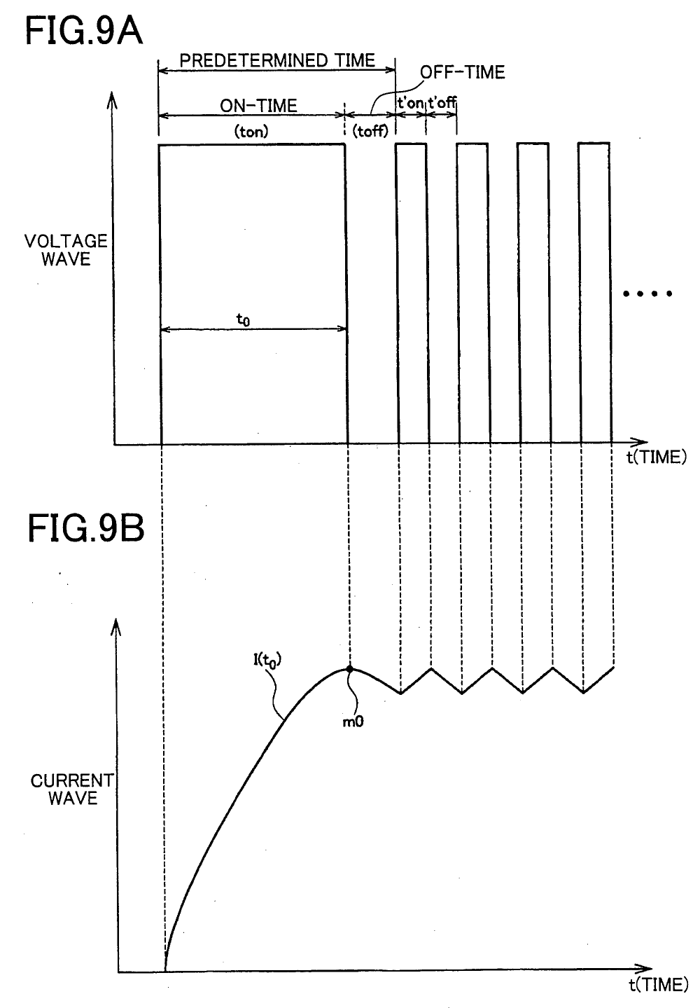

And FIGS. 9A, 10A and 11A show the voltage wave against the time during which the on-time and the off-time of the pulse signal are repeatedly executed. As shown in FIGS. 9A, 10A and 11A, the on-time (ton) become shorter according to the order of t0, t1 and t2. And the off-time (toff) is retained to a constant time in the embodiment. Here, as shown in FIGS. 9A, 10A and 11A, the above on-time (ton) and the off-time (toff) are repeated till the predetermined time is elapsed. On the other hand, after the predetermined time is elapsed, the on-time (t′on) and the off-time (t′off) are repeated in the embodiment.

Here, as shown in FIG. 8, if the winning combination is the “water melon”, the main CPU 31 sets “t0” as the on-time which is corresponded to the “water melon”. Similarly, if the winning combination is the “RB (Regular Bonus), the main CPU 31 sets “t1” as the on-time which is corresponded to the “RB”. And if the winning combination is the “BB (Big Bonus), the main CPU 31 sets “t2” as the on-time which is corresponded to the “BB”. Here, in FIG. 8, the winning combination generally becomes more and more beneficial for the player according to that the winning combination goes down, that is, in order of the loss of winning combination, the bell, the corner cherry, the center cherry, the replay, the water melon, the RB and the BB. And the on-time becomes shorter and shorter according to that the on-time goes down, that is, there is a relation of t0>t1>t2. Therefore, as understandable from FIG. 8, the on-time is made shorter according to that the winning combination becomes more beneficial for the player.

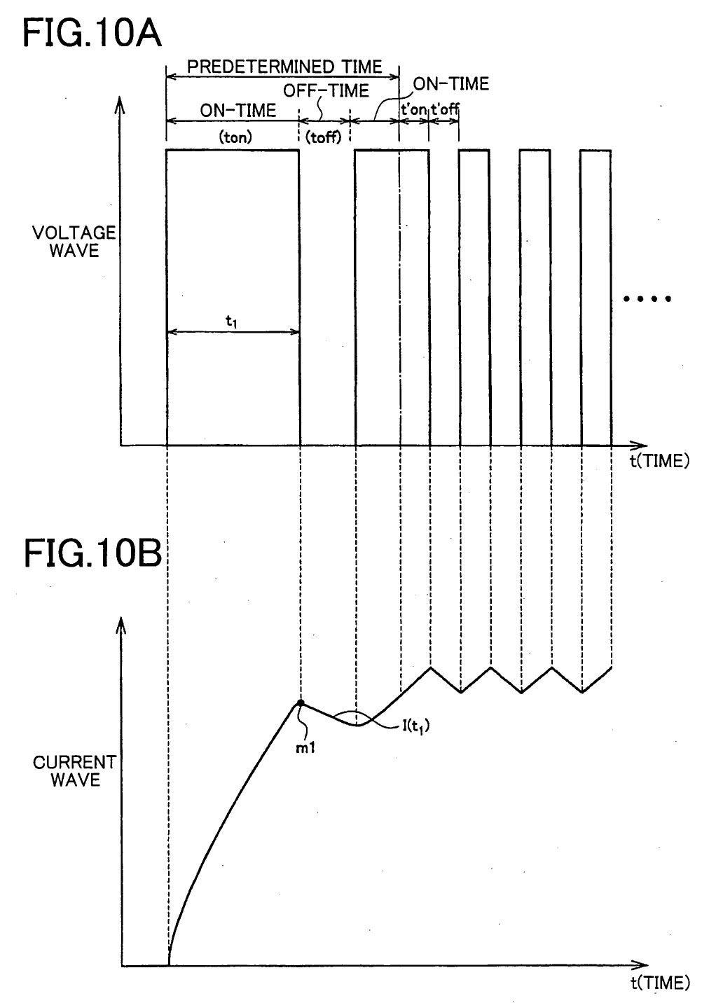

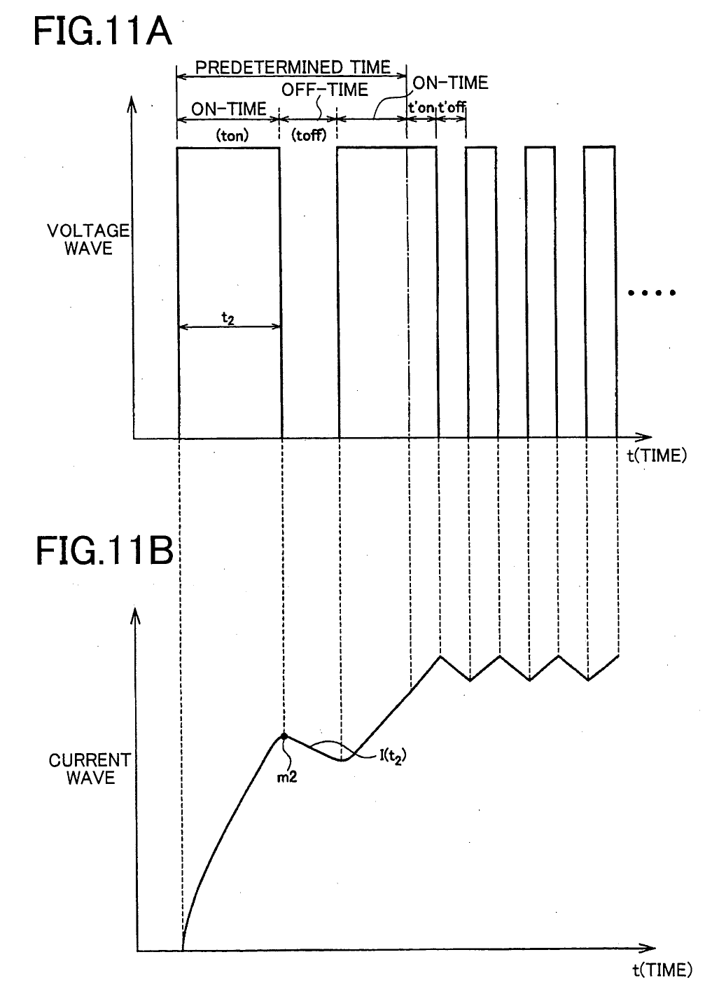

FIGS. 9B, 10B and 11B show the current wave against the time during which the on-time and the off-time of the pulse signal are repeatedly executed. I (t0) shown in FIG. 9B means the current wave when the on-time is “t0”. And I (t1) and I (t2) shown in FIGS. 10B, 11B respectively are also mean the current wave when the on-time is “t1”, “t2”, respectively.

As shown in FIG. 9B, in a case that the on-time is “t0” which is the longest, the time that the voltage is applied to the stepping motor 49 at the drive start thereof becomes the longest. Thereby, the current value (the current value at “m0” shown in FIG. 9B) flowing in the stepping motor 49 at the drive start thereof becomes larger than the current value during the on-time t1 (the current value at “m1” shown in FIG. 10B and the current value during the on-time t2 (the current value at “m2” shown in FIG. 11B).

In other words, according to that the on-time becomes shorter in order of “t0”, “t1”, “t2”, the maximum current value applied to the stepping motor 49 at the drive start thereof gradually becomes shorter (for example, the current value becomes shorter in order of the current value at “m0” shown in FIG. 9B→the current value at “m1” shown in FIG. 10B→the current value at “m2” shown in FIG. 11B).

Therefore, the current value I (t0) flowing in the stepping motor 49 at the drive start thereof becomes larger than the current value I (t1) flowing in the stepping motor 49 at the drive start thereof and the current value I (t2) flowing in the stepping motor 49 at the drive start thereof, thus the stepping motor 49 quickly rotates at the drive start thereof.

And according to that the current flowing in the stepping motor 49 at the drive start thereof becomes smaller in order of the current I (t0), the current I (t1), the current I (t2), the stepping motor 49 slowly rotates at the drive start thereof, in comparison with a case that the on-time is “t0”.

Therefore, based on that the main CPU 31 changes the current value at the drive start of the stepping motor 49, the start process of the stepping motor 49 is changed. Thereby, the rotation mode of the reels 3 in the reel-type gaming machine 1 at the rotation start can be voluntarily changed, thus interest for games can be raised.

Here, the motor drive circuit 31, as shown in FIG. 9A, may repeatedly apply the pulse signal having the on-time determined by the main CPU 31 (for example, ton) and the off-time preset beforehand (for example, toff) to the stepping motor 49 during a time till the predetermined time is elapsed since the drive instruction of the stepping motor 49 occurs by the instruction from an external, and after the predetermined time is elapsed, the motor drive circuit 31 may repeatedly apply the pulse signal having the on-time (for example, t′on) preset beforehand and the off-time (for example, t′off) preset beforehand to the stepping motor 49, thereby the stepping motor 49 may be driven.

And when the drive instruction of the stepping motor 49 occurs by the instruction from an external, the motor drive circuit 31 may repeatedly apply the pulse signal having the on-time determined by the main CPU 31 (for example, ton) and the off-time preset beforehand (for example, toff) to the stepping motor 49 till the pulse number of the pulse signal reaches to the predetermined standard number, thereby the stepping motor 49 may be driven.

In ST13, the main CPU 31 extracts the random number which is utilized for various determinations.

In ST 14, the main CPU 31 sets a predetermined time to the 1 game observation timer. Here, the 1 game observation timer includes an automatic stop timer to which a predetermined time is set in order to automatically stop the reels 3 without stop operation by the player.

In ST15, the main CPU 31 conducts the game state observation process.

In ST16, the main CPU 31 determines whether or not the stop buttons 7L, 7C, 7R are operated by the player. Concretely, the main CPU 31 determines whether or not the input from the reel stop signal circuit 46 is “on”. And if such input from the reel stop signal circuit 46 is “on”, the main CPU 31 shifts the procedure to ST 18. On the other hand, if the input from the reel stop signal circuit 46 is “off”, the main CPU 31 shifts the procedure to ST17.

In ST17, the main CPU 31 determines whether or not the value of the automatic stop timer is “0”. And if such value is “0”, the main CPU 31 conducts the process in ST18. On the other hand, if such value is not “0”, the main CPU 31 conducts the process in ST17.

In ST18, the main CPU 31 determines the number of slide symbols.

In ST20, the main CPU 31 conducts the process to stop the reels 3.

In ST21, the main CPU 31 determines whether or not all reels 3 are stopped. And if all reels 3 are stopped, the main CPU 31 conducts the process in ST21. On the other hand, if all reels 3 are not stopped, the main CPU 31 conducts the process in ST16.

In ST22, the main CPU 31 sets the command indicating that all reels 3 are stopped.

In ST23, the main CPU 31 conducts determination of a win (the winning combination). Here, the determination of a win (the wining combination) means that the winning flag is set in order to distinguish the winning combination based on the stop mode of the symbols along the panel display windows 5L, 5C, 5R. Concretely, the main CPU 31 distinguish the winning combination based on the code numbers of the symbols stopped along the center pay line and the winning combination determination table (not shown).

In ST24, the main CPU 31 determines whether or not the winning flag is normal. And if the winning flag is normal, the main CPU 31 conducts the process in ST26. On the other hand, if the winning flag is not normal, the main CPU 31 conducts the process in ST 25.

In ST25, the main CPU 31 conducts the display of illegal error.

In ST26, the main CPU 31 stores or pays out the medals corresponding to the winning combination.

In ST27, the main CPU 31 determines whether game condition is the “BB general game state” or the “RB game state”. And if game condition is the “BB general game state” or the “RB game state”, the main CPU 31 conducts the process in ST28. On the other hand, if game condition is not the “BB general game state” or the “RB game state”, the main CPU 31 terminates procedure.

In ST28, the main CPU 31 checks the number of the BB game and the number of the RB game. In this process, for example, the game number of the “BB general game state”, the occurrence number of the “RB game state” in the “BB general game state”, the game number in the “RB game state” and the winning number of times in the “RB game state” are checked.

In ST29, the main CPU 31 determines whether or not the “BB general game state” or the “RB game state” is terminated. And if games in the “BB general game state” or the “RB game state” are terminated, the main CPU 31 conducts the process in ST30. On the other hand, if games in the “BB general game state” or the “RB game state” are not terminated, the main CPU 31 conducts the process in ST2.

In ST30, the main CPU 31 clears the work area in the main RAM 33, the work area being used in the “BB general game state” or the “RB game state”.

Here, the present invention is not limited to the above embodiment and various modifications may be done within the scope of the present invention. For example, although the stop control of the reels 3L, 3C, 3R is conducted based on the signal output from the reel stop signal circuit 46 when any one of the stop buttons 7L, 7C, 7R is pressed, the present invention is not limited to this. The reels 3L, 3C, 3R may be automatically stopped after a predetermined time is elapsed.

(Operation and Effect by the Motor Drive Control Device)

According to the motor drive control device of the present invention, when the drive instruction of the stepping motor 49 occurs based on the instruction from an external, the motor drive circuit 39 repeatedly applies the pulse signal having the on-time and the off-time to the stepping motor 49, thereby the motor drive control device can efficiently drive the stepping motor 49 with a lower voltage value. Therefore, the power source in the reel-type gaming machine can be commonly utilized and manufacturing cost of the reel-type gaming machine can be reduced.

And the main CPU 31 determines the on-time corresponding to kinds of the winning combinations, thereby the motor drive control device can voluntarily change the current value flowing in the stepping motor 49 at the drive start of the stepping motor 49. Accordingly, rotation mode of the reels 3 at the rotation start thereof can be variously changed and interest for games can be raised.

1. A motor drive control device utilizable for a gaming machine comprising:
a motor for rotating a reel on which a plurality of symbols are formed; and
a motor drive controller for driving and controlling the motor;
wherein the motor drive controller repeatedly applies a pulse signal with an on-time and an off-time to the motor based on a motor drive instruction.

2. The motor drive control device according to claim 1, further comprising:
a winning combination determination device for determining plural kinds of winning combinations by a lottery; and
an on-time determination device for determining the on-time corresponding to the kind of the winning combination determined by the winning combination determination device.

3. The motor drive control device according to claim 2, further comprising:
a selection lottery table in which the plural kinds of the winning combinations and plural kinds of the on-times are stored so that each kind of the winning combinations corresponds to each kind of the on-times;
wherein the on-time determination device determines the on-time with reference to the selection lottery table.

4. The motor drive control device according to claim 3, wherein the on-time is made shorter according to that the winning combination becomes more beneficial for a player.

5. The motor drive control device according to claim 2, wherein the off-time is set to a constant time.

6. The motor drive control device according to claim 1, wherein the motor drive controller drives the motor by a chopping control method in which an on-state and an off-state of the pulse signal are repeated.

7. The motor drive control device according to claim 3, wherein the longer the on-time becomes the larger a current value flowing in the motor becomes, thereby the motor is rapidly rotated at a start of rotation.

8. The motor drive control device according to claim 3, wherein the shorter the on-time becomes the smaller a current value flowing in the motor becomes, thereby the motor is slowly rotated at a start of rotation.

9. The motor drive control device according to claim 1, wherein the motor drive controller repeatedly applies a pulse signal with an on-time and an off-time to the motor till a pulse number of the pulse signal reaches to a predetermined number.

10. A gaming machine comprising:
a motor drive control device;
wherein the motor control device comprises:
a motor for rotating a reel on which a plurality of symbols are formed; and
a motor drive controller for driving and controlling the motor;
wherein the motor drive controller repeatedly applies a pulse signal with an on-time and an off-time to the motor based on a motor drive instruction.
